(19) United States
(12) Patent Application Publication
(10) Pub. No.: US 2006/0190875 A1
(43) Pub. Date: Aug. 24, 2006

(54) Pattern extracting system, method for extracting measuring points, method for extracting patterns, and computer program product for extracting patterns

(76) Inventors: Yukiyasu Arisawa, Tokyo (JP); Osamu Ikenaga, Yokohama-shi (JP); Shigeki Nojima, Yokohama-shi (JP); Shigeru Hasebe, Oita-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/325,515

(22) Filed: Jan. 5, 2006

(30) Foreign Application Priority Data
Jan. 7, 2005 (JP) P2005-2939

(51) Int. Cl. G06F 17/50

(52) U.S. Cl. 716/5

(57) ABSTRACT

A pattern extracting system includes a sampler configured to sample test candidate patterns from a circuit pattern, based on a lithographic process tolerance, a space classification module configured to classify the test candidate patterns into space distance groups depending on a space distance to an adjacent pattern, a density classification module configured to classify the test candidate patterns into pattern density groups depending on a surrounding pattern density, and an assessment module configured to assess actual measurements of dimensional errors of the test candidate patterns classified into the space distance groups and the pattern density groups.

### CROSS REFERENCE TO RELATED APPLICATIONS AND INCORPORATION BY REFERENCE

This application is based upon and claims the benefit of priority from prior Japanese Patent Application P2005-002939 filed on Jan. 7, 2005; the entire contents of which are incorporated by reference herein.

### BACKGROUND OF THE INVENTION

1. Field of the Invention

The present invention relates to lithographic process and in particular to pattern extracting system, method for extracting measuring points, method for extracting patterns, and computer program product for extracting the patterns.

2. Description of the Related Art

Recently, the requirements on dimensional accuracy of mask patterns on a photomask have become strict. Dimensional uniformity of the mask patterns on the photomask has seen especially high requirements. Also, a reliability of a guarantee on the dimensional accuracy of the mask patterns has been strictly assessed. Therefore, it is necessary to establish an appropriate method for assessing the dimensional uniformity of the mask patterns. When the dimensional uniformity of the mask patterns is assessed on the photomask, it is not realistic to inspect all dimensions of the mask patterns. Therefore, in Japanese Patent Laid-Open Publication No. 2000-81697, a simulator simulates a formation of the projected images of the mask patterns to extract patterns affecting dimensional variations of the projected images of the mask pattern. Thereafter, such extracted patterns on the photomask are actually inspected.

### SUMMARY OF THE INVENTION

An aspect of present invention inheres in a pattern extracting system according to an embodiment of the present invention. The system includes a sampler configured to sample a plurality of test candidate patterns from a circuit pattern, based on a lithographic process tolerance. A space classification module is configured to classify the plurality of test candidate patterns into a plurality of space distance groups depending on a space distance to an adjacent pattern. A density classification module is configured to classify the plurality of test candidate patterns into a plurality of pattern density groups depending on a surrounding pattern density. An assessment module is configured to assess actual measurements of dimensional errors of the plurality of test candidate patterns classified into the plurality of space distance groups and the plurality of pattern density groups.

Another aspect of the present invention inheres in a method for extracting measuring points according to the embodiment of the present invention. The method includes sampling a plurality of measuring points from a circuit pattern, based on a lithographic process tolerance, classifying the plurality of measuring points into a plurality of correction parameter groups depending on a correction parameter, the correction parameter being used to correct the circuit pattern, classifying the plurality of measuring points into a plurality of design parameter groups depending on a design parameter, the design parameter being not used to correct the circuit pattern, and extracting the plurality of measuring points classified into the plurality of correction parameter groups and the plurality of design parameter groups.

Yet another aspect of the present invention inheres in a method for extracting the patterns according to the embodiment of the present invention. The method includes sampling a plurality of test candidate patterns from a circuit pattern, based on a lithographic process tolerance, classifying the plurality of test candidate patterns into a plurality of space distance groups depending on a space distance to an adjacent pattern, classifying the plurality of test candidate patterns into a plurality of pattern density groups depending on a surrounding pattern density, and assessing actual measurements of dimensional errors of the plurality of test candidate patterns classified into the plurality of space distance groups and the plurality of pattern density groups.

Yet another aspect of the present invention inheres in a computer program product for controlling a computer system so as to extract the patterns according to the embodiment of the present invention. The computer program product includes instructions configured to sample a plurality of test candidate patterns from a circuit pattern, based on a lithographic process tolerance, instructions configured to classify the plurality of test candidate patterns into a plurality of space distance groups depending on a space distance to an adjacent pattern, instructions configured to classify the plurality of test candidate patterns into a plurality of pattern density groups depending on a surrounding pattern density, and instructions configured to assess actual measurements of dimensional errors of the plurality of test candidate patterns classified into the plurality of space distance groups and the plurality of pattern density groups.

### BRIEF DESCRIPTION OF DRAWINGS

FIG. 1 is a diagram of a pattern extracting system in accordance with an embodiment of the present invention;

FIG. 2 is a first plan view of a photomask in accordance with the embodiment of the present invention;

FIG. 3 is a second plan view of the photomask in accordance with the embodiment of the present invention;

FIG. 4 is a third plan view of the photomask in accordance with the embodiment of the present invention;

FIG. 5 is a table showing the sample number of test candidatepatterns classified into space distance groups and pattern density groups in accordance with the embodiment of the present invention;

FIG. 6 is a graph showing frequency versus pattern density in accordance with the embodiment of the present invention;

FIG. 7 is a flowchart depicting a method for extracting patterns in accordance with the embodiment of the present invention;

FIG. 8 is a graph showing line width versus surrounding pattern density in accordance with the embodiment of the present invention;

FIG. 9 is the diagram of the pattern extracting system in accordance with a modification of the embodiment of the present invention;

FIG. 10 is the flowchart depicting the method for extracting patterns in accordance with the modification of the embodiment of the present invention;

FIG. 11 is a table showing the sample number of test candidate patterns classified into correction parameter groups and design parameter in accordance with the modification of the embodiment of the present invention; and

FIG. 12 shows divided areas in accordance with other embodiment of the present invention.

### DETAILED DESCRIPTION OF THE INVENTION

An embodiment of the present invention will be described with reference to the accompanying drawings. It is to be noted that the same or similar reference numerals are applied to the same or similar parts and elements throughout the drawings, and the description of the same or similar parts and elements will be omitted or simplified.

Since there are limits on computer processing time and computer performance, an area on a photomask where optical proximity correction (OPC) can be applied is limited to the order of 10 square micrometers. It is difficult to suppress pattern dimensional variations of a mask pattern caused by a pattern density of an area larger than 100 square micrometers. Therefore, assessing the pattern dimensional variations caused by the pattern density of an area surrounding a target area where the OPC is applied is important to guarantee the photomask quality. When the OPC is applied to the mask pattern on the photomask, the amount of the OPC is determined to obtain a desirable projected image of the mask pattern on a wafer based on features of the mask pattern such as a line width and a space between adjacent mask patterns. Hereinafter, such features are called as “incidental features of the patterns”. Even though the projected images of the mask patterns are designed to have identical dimensions on the wafer, both mask patterns may be designed to have different dimensions on the designed photomask in the case where the mask patterns are placed in different areas having different surrounding pattern densities. To guarantee the photomask quality, statistics of differences (ΔCD) between actual dimensions and designed dimensions of the mask patterns are used as an index to determine the photomask quality. However, it is impossible to establish a consistency between the designed dimensions of the mask pattern and the dimensions of the projected image, since the designed dimensions of the mask pattern may be corrected by the OPC. Therefore, only assessing the ΔCD may fail to assess the photomask quality. To guarantee the photomask quality accurately, it is important to consider the “incidental features of the patterns”. The embodiment of the present invention aims at classifying the mask patterns depending on the “incidental features of the patterns”. The classified mask patterns have been equally corrected by the OPC. By using such classification, an accurate guarantee on the photomask quality is provided. In addition, there is a case where it is impossible to consider all of the “incidental features of the patterns”. In such a case, the classified mask patterns may have dimensional variations caused by the disregarded “incidental features of the patterns”. The embodiment of the present invention also aims at eliminating such affect of the disregarded “incidental features of the patterns” to provide a higher degree of guarantee on the photomask quality. Since there are a very large number of “incidental features of the patterns”, it is not efficient to use all “incidental features of the patterns” to classify the mask patterns. Among the “incidental features of the patterns”, the space between the adjacent mask patterns strongly affects a lithographic process tolerance when the mask patterns are projected onto the wafer. Also, the space between the adjacent mask patterns strongly affects the dimensional variations of the mask patterns when the photomask is manufactured. Therefore, the mask patterns exhibiting narrow lithographic process tolerances are classified depending on the space between the adjacent mask patterns. Such classified mask patterns are expected to have narrow dimensional dispersion. However, such classified mask patterns may have a certain amount of dimensional dispersion because of the disregarded “incidental features of patterns”. The pattern density of an area where the OPC is not applied is a representative “incidental features of patterns”. Such pattern density also affects the dimensional variations of the mask patterns.

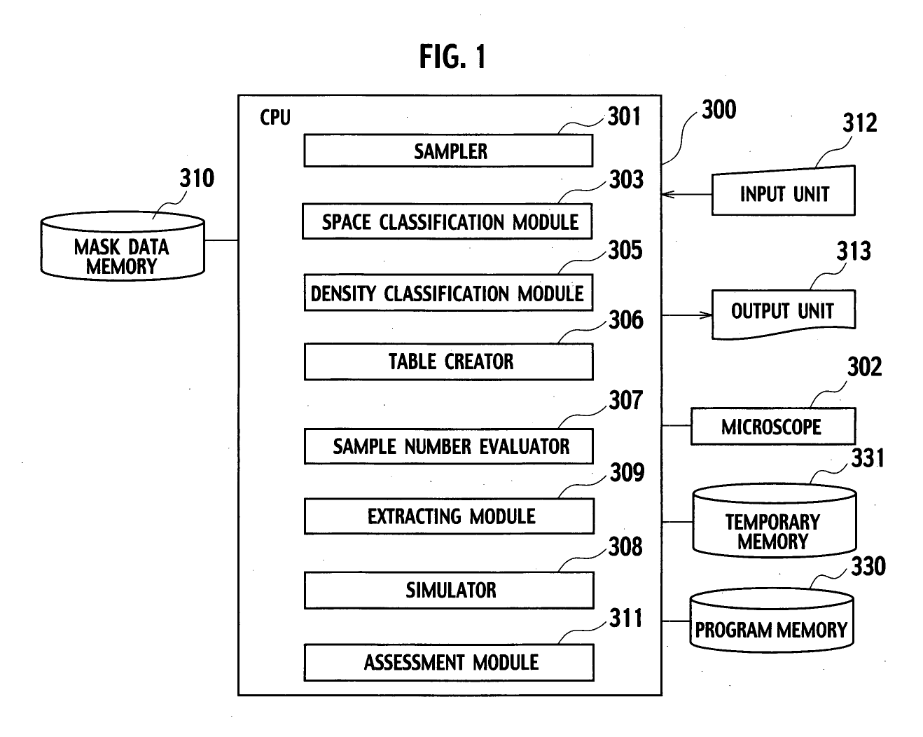

With reference to FIG. 1, a pattern extracting system in accordance with the embodiment of the present invention includes a central processing unit (CPU) 300. The CPU 300 includes a sampler 301 configured to sample a plurality of test candidate patterns from a circuit pattern based on the lithographic process tolerance. A space classification module 303 in the CPU 300 is configured to classify the plurality of test candidate patterns into a plurality of space distance groups depending on a space distance to an adjacent pattern. A density classification module 305 in the CPU 300 is configured to classify the plurality of test candidate patterns into a plurality of pattern density groups depending on a surrounding pattern density. A table creator 306 in the CPU 300 is configured to create a table containing a sample number of the plurality of test candidate patterns classified into the space distance groups and the pattern density groups.

The CPU 300 further includes a sample number evaluator 307, an extracting module 309, a simulator 308, and a assessment module 311. A microscope 302, a mask data memory 310, a program memory 330, a temporary memory 331, an input unit 312, and an output unit 313 are connected to the CPU 300.

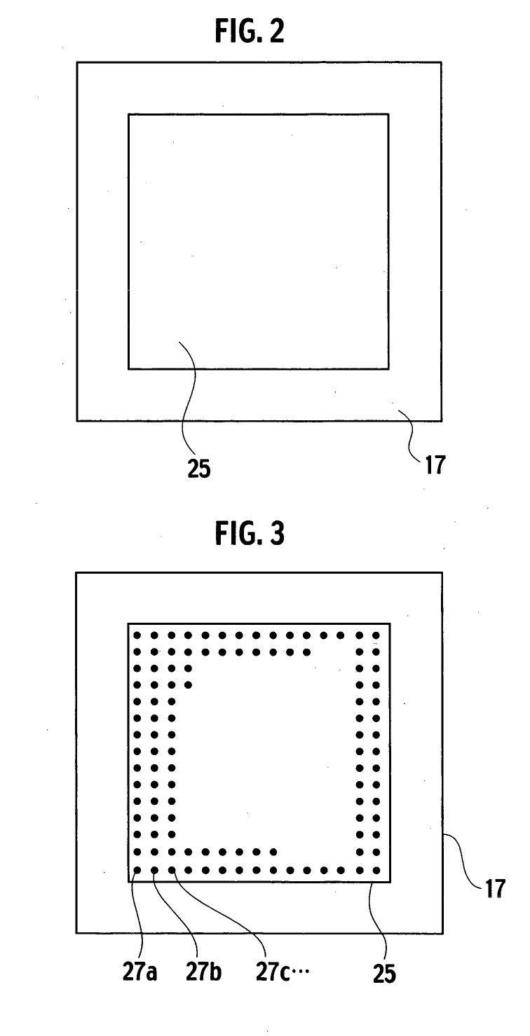

The mask data memory 310 stores mask data of the photomask shown in FIG. 2. The photomask includes a device pattern area 25 and a shield area 17 surrounding the device pattern area 25. The computer aided design (CAD) data can be used for the mask data, for example. The mask pattern is arranged in the device pattern area 25 as the circuit pattern.

The simulator 308 shown in FIG. 1 executes a plurality of lithography simulation programs by using the mask data stored in the mask data memory 310. Such programs may employ a Fourier transform to calculate an optical intensity of the projected image of the mask pattern and a string model to calculate the critical dimension of the projected mask pattern in the developed resist layer. The simulator 308 reads a plurality of parameters for the lithography simulation programs such as a wavelength of a light irradiated on the photomask, a numerical aperture of a lens to project the mask pattern, a coherence factor, a thickness of the resist layer, and a developing rate of the resist layer.

The sampler 301 samples a plurality of narrow margin points 27a, 27b, 27c, . . . shown in FIG. 3 from the device pattern area 25 shown in FIG. 2 based on the simulated projected image of the mask pattern by the simulator 308 or the actual resist pattern. Each of the narrow margin points 27a, 27b, 27c, . . . has the low lithographic process tolerance to dose variation, focus length variation, and developing rate variation. Specifically, the low lithographic process tolerance means that the depth of focus (DOF) is below 0.2 micrometers. The lithographic process tolerance of each of the narrow margin points 27a, 27b, 27c, . . . is calculated by the simulator 308. Alternatively, the sampler 301 samples the plurality of narrow margin points 27a, 27b, 27c, . . . based on an actual projected image of the mask pattern of the photomask on the resist layer. Such actual image is observed by the microscope 302. The microscope 302 observes the shape and dimension of the mask pattern on the photomask shown in FIG. 2. Also, the microscope 302 observes the shape and dimension of the projected image of the mask pattern formed by projecting the photomask onto the resist layer. An atomic force microscope (AFM) and a scanning electron microscope (SEM) can be used for the microscope 302, for example. Further, the sampler 301 shown in FIG. 1 extracts the plurality of portions of the mask pattern containing the plurality of narrow margin points 27a, 27b, 27c, . . . , respectively, from the mask data memory 310.

The space classification module 303 classifies the plurality of test candidate patterns extracted by the sampler 301 into a first space distance group “S₁”, a second space distance group “S₂”, a third space distance group “S₃”, . . . , an “n”-th space distance group “Sₙ”, . . . , and an “m”-th space distance group “Sₘ” depending on the space distance to the adjacent mask pattern. Here, “n” is a natural number and “m” is the total number of the space distance groups. For example, the space distances of the test candidate patterns classified into the “n”-th space distance group “Sₙ” range from 2 (n-1) micrometers to 2n micrometers.

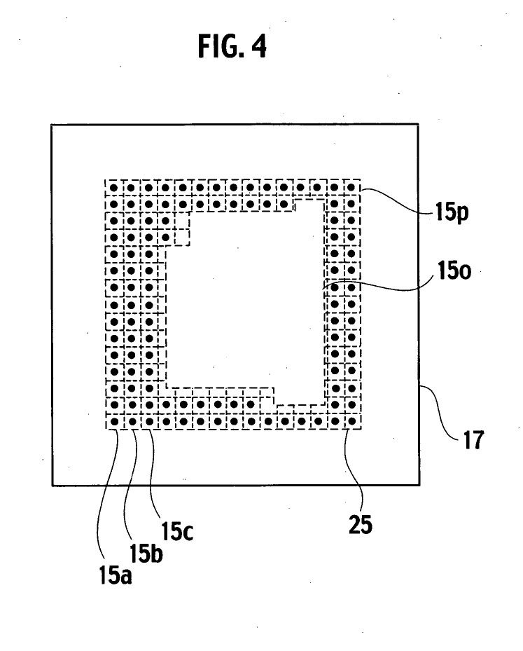

The density classification module 305 defines a first divided area 15a, a second divided area 15b, a third divided area 15c, . . . , an “o”-th divided area 15o, . . . , and a “p”-th divided area 15p where the plurality of narrow margin points 27a, 27b, 27c, . . . center, respectively, as shown in FIG. 4. Here, “o” is a natural number and “p” is the total number of divided areas. Each square measure of the divided areas depends on the lithographic process tolerance using the photomask. Generally, the square measure ranges form 1 square centimeter to 99 square centimeters.

Further, the density classification module 305 shown in FIG. 1 calculates each pattern density of the first to “p”-th divided areas 15a-15p shown in FIG. 4. Also, the density classification module 305 classifies the first to “p”-th divided areas 15a-15p into a first pattern density group “D₁” a second pattern density group “D₂”, a third pattern density group “D₃”, . . . , a “q”-th pattern density group “D_{q}”, . . . , and an “r”-th pattern density group “Dᵣ”. Here, “q” is a natural number and “r” is the total number of pattern density groups. For example, the pattern densities of the divided areas classified into the “q”-th pattern density group “D_{q}” ranges from 4 (q-1) % to 4q %. Also, the density classification module 305 shown in FIG. 1 determines where each of the test candidate patterns classified into the first to “m”-th space distance groups “S₁”-“Sₘ” is located among the first to “p”-th divided areas 15a-15p shown in FIG. 4. Further, the density classification module 305 shown in FIG. 1 classifies the test candidate patterns into the first to “r”-th pattern density groups “D₁”-“Dᵣ”.

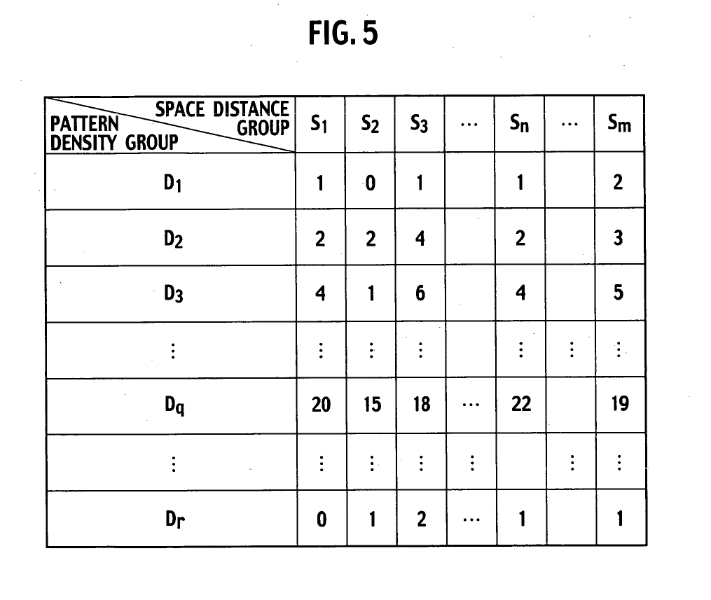

With reference to FIG. 5, the table creator 306 creates the table showing each sample number of the test candidate patterns classified into the first to “m”-th space distance groups “S₁”-“Sₘ” and the first to “r”-th pattern density groups “D₁”-“Dᵣ”.

The sample number evaluator 307 shown in FIG. 1 determines whether or not the total sample number of the test candidate patterns contained in the table shown in FIG. 5 is above the permissible number of measuring points by the microscope 302 shown in FIG. 1. The microscope 302 such as the AFM and the SEM makes it possible to observe a limitless number of samples in principle. However, if the processing time is considered, the practical sample number is limited. Therefore, the sample number evaluator 307 defines the practical sample number that can be treated by the microscope 302 for a certain period as being the “permissible number of the measuring points”. Alternatively, the permissible number of the measuring points is transferred from the input unit 312 to the sample number evaluator 307 by an operator.

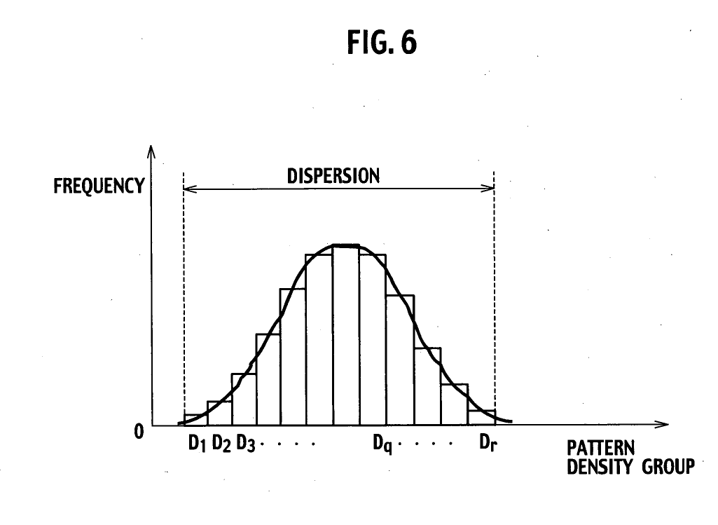

With reference to FIG. 6, the extracting module 309 calculates a dispersion of each of the first to “m”-th space distance group “S₁”-“Sₘ” based on the table shown in FIG. 5. Further, the extracting module 309 calculates assigned measuring points “MPₙ” of the “n”-th space distance group “Sₙ” by using an equation (1).

$${MP}_{n} = ( {N}_{n} / {\sum }_{n = 1}^{m} {N}_{n} ) \times PN \qquad ( 1 )$$

Here “Nₙ” is a sample number contained in the “n”-th space distance group “Sₙ”. “PN” is the permissible number of the measuring points.

Further, the extracting module 309 extracts the test candidate patterns in the “n”-th space distance group “Sₙ” from the first to “r”-th pattern density groups “D₁”-“Dᵣ”, as follows. The extracting module 309 extracts the test candidate patterns in the “n”-th space distance group “Sₙ” from the first pattern density group “D₁”, the second pattern density group “D₂”, the third pattern density group “D₃”, . . . , one by one. Here, the first pattern density group “D₁” is the lowest pattern density group having the lowest surrounding pattern density among the first to “r”-th pattern density groups “D₁”-“Dᵣ”. The extracting module 309 defines a group of the extracted test candidate patterns as being a low density group. Simultaneously, the extracting module 309 defines the sum of the sample numbers of the extracted test candidate patterns as being the low density group sample number.

Also, the extracting module 309 extracts the test candidate patterns in the “n”-th space distance group “Sₙ” form the “r”-th pattern density group “Dᵣ”, the “r-1”-th pattern density group “Dᵣ₋₁”, the “r-2”-th pattern density group “Dᵣ₋₂”, one by one. Here, the “r”-th pattern density group “Dᵣ” is the highest pattern density group having the highest surrounding pattern density among the first to “r”-th pattern density group “D₁”-“Dᵣ”. The extracting module 309 defines a group of the extracted test candidate patterns as being a high density group. Simultaneously, the extracting module 309 defines the sum of the sample numbers of the extracted test candidate patterns as being the high density group sample number.

The extracting module 309 calculates the sum of the low density group sample number and the high density group sample number for every time the low density group sample number and the high density group sample number are calculated. When the sum of the low density group sample number and the high density group sample number reaches the assigned measuring points “MPₙ” of the “n”-th space distance group “Sₙ”, the extracting module 309 stops extracting the test candidate patterns from the “n”-th space distance group “Sₙ”.

An index “Vₙ” of the dimensional variation of the “n”-th space distance group “Sₙ” is given by an equation (2).
Vₙ=|μ_{nH}−μ_{nL}|+α(σ_{nH}+σ_{nL}) (2)

Here, “μ_{nH}” is an average of actual dimensional errors of the extracted test candidate patterns in the high density group. “μ_{nL}” is an average of actual dimensional errors of the extracted test candidate patterns in the low density group. “σ_{nH}” is a standard deviation of the actual dimensional errors of the extracted test candidate patterns in the high density group “σ_{nL}” is a standard deviation of the actual dimensional errors of the extracted test candidate patterns in the low density group. “α” depends ona confidence interval of an estimation. Generally, “α” is about three.

The assessment module 311 calculates an index “Q_{P}” of the photomask quality showing the dimensional variation caused by the pattern density based on the actual measurements of the dimensions of the test candidate patterns in the device pattern area 25 shown in FIG. 2. Such actual measurements of the dimensions of the test candidate patterns are measured by the microscope 302.

In the case where the number of the test candidate patterns is below the permissible number “PN” of the measuring points, the assessment module 311 calculates the square of the standard deviation σ(Sₙ)² of the actual dimensional errors of the test candidate patterns in each of the first to “m”-th space distance groups “S₁”-“Sₘ”. The assessment module 311 multiplies the summation of the square of the standard deviation σ(Sₙ)² by 2α to calculate the index “Q_{P}” of the photomask quality showing the dimensional variation caused by the pattern density of the photomask shown in FIG. 2. The index “Q_{P}” is given by equation (3).

$${Q}_{P} = \sqrt{2 α \times {\sum }_{n = 1}^{m} {σ ( {S}_{n} )}^{2}} \qquad ( 3 )$$

In the case where the number of the test candidate patterns is above the permissible number “PN” of the measuring points, the assessment module 311 calculates the index “Vₙ” of the dimensional variation of the “n”-th space distance group “Sₙ” by using the equation (2). Further, the assessment module 311 calculates the square root of the summation of the index “Vₙ” to provide the index “Q_{P}” of the photomask quality showing the dimensional variation caused by the pattern density of the photomask shown in FIG. 2. The index “Q_{P}” is given by equation (4).

$${Q}_{P} = \sqrt{{\sum }_{n = 1}^{m} {V}_{n}} \qquad ( 4 )$$

With reference again to FIG. 1, a keyboard and a mouse may be used for the input unit 312. A printer and display devices such as a liquid crystal display (LCD) and a cathode ray tube (CRT) display can be used for the output unit 313, for example. The program memory 330 stores a program instructing the CPU 300 to transfer data with apparatuses connected to the CPU 300. The temporary memory 331 stores temporary data calculated during operation by the CPU 300. Computer readable mediums such as semiconductor memories, magnetic memories, optical discs, and magneto optical discs can be used for the program memory 330 and the temporary memory 331, for example.

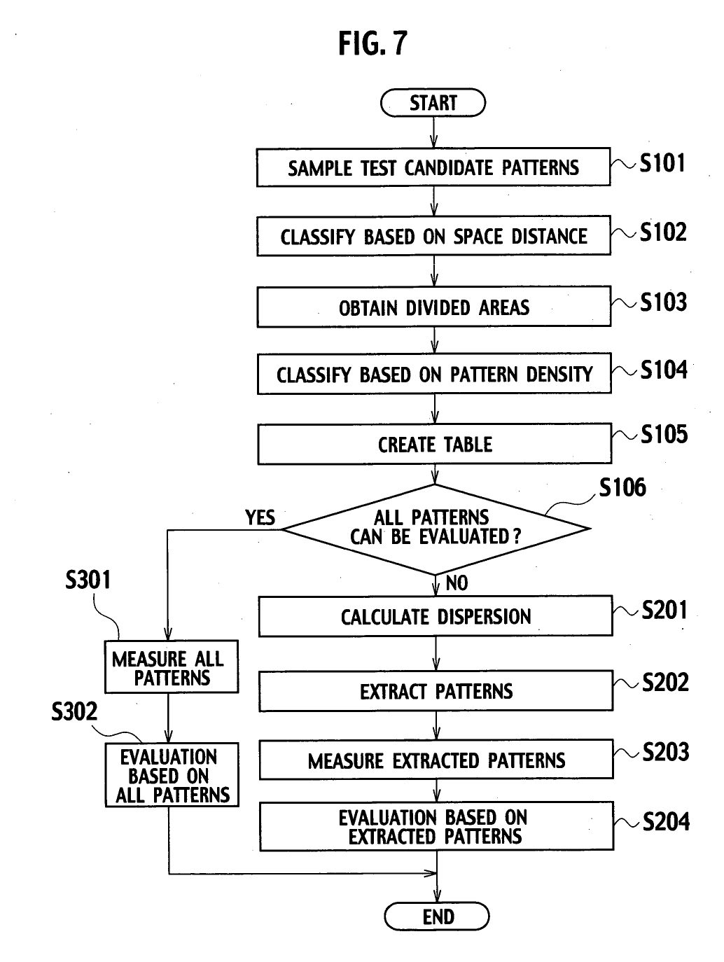

With reference to FIG. 7, a method for extracting patterns in accordance with the embodiment of the present invention is described.

In step S101, the simulator 308 shown in FIG. 1 simulates the projected image formation when the mask pattern on the photomask shown in FIG. 2 is projected onto the resist layer coated on the wafer. Thereafter, the sampler 301 shown in FIG. 1 samples the plurality of narrow margin points 27a, 27b, 27c, . . . shown in FIG. 3 from the device pattern area 25 on the photomask shown in FIG. 2 based on the simulated projected image by the simulator 308. Each of the narrow margin points 27a, 27b, 27c, . . . has the low lithographic process tolerance such as the depth of the focus. Further, the sampler 301 samples the portions of the mask pattern containing the narrow margin points 27a, 27b, 27c, . . . , respectively, from the mask data memory 310 shown in FIG. 1 as the test candidate patterns.

In step S102, the space classification module 303 shown in FIG. 1 classifies the test candidate patterns sampled by the sampler 301 into the first to “m”-th space distance groups “S₁”-“Sₘ” depending on the space distance to the adjacent mask pattern. In step S103, the density classification module 305 defines the first to “p”-th divided areas 15a-15p as shown in FIG. 4. The centers of the first to “p”-th divided areas 15a-15p are the narrow margin points 27a, 27b, 27c, . . . , respectively. Then, the density classification module 305 shown in FIG. 1 calculates each pattern density of the first to “p”-th divided areas 15a-15p. Thereafter, the density classification module 305 classifies the first to “p”-th divided are as 15a-15p into the first to “r”-th pattern density groups “D₁”-“Dᵣ”.

In step S104, the density classification module 305 determines where each the test candidate patterns classified into the first to “m”-th space distance groups “S₁”-“Sₘ” is located among the first to “p”-th divided areas 15a-15p. Thereafter, the density classification module 305 further classifies the test candidate patterns contained in the first to “m”-th space distance groups “S₁”-“Sₘ” into the first to “r”-th pattern density groups “D₁”-“Dᵣ” depending on the pattern density. In step S105, as shown in FIG. 5, the table creator 306 creates the table showing each sample number of the test candidate patterns classified into the first to “m”-th space distance groups “S₁”-“Sₘ” and the first to “r”-th pattern density groups “D₁”-“Dᵣ”.

In step S106, the sample number evaluator 307 shown in FIG. 1 determines whether the total sample number of the test candidate patterns contained in the table shown in FIG. 5 is above the permissible number “PN” of the measuring points by the microscope 302 shown in FIG. 1. If the total sample number is above the permissible number “PN” of the measuring points, step S201 is the next procedure. If the total sample number is below the permissible number “PN” of the measuring points, step S301 is the next procedure.

In step S201, as shown in FIG. 6, the extracting module 309 calculates the dispersion of the pattern density on each of the first to “m”-th space distance groups “S₁”-“Sₘ”. In step S202, in a case where “n” is 1 to “m”, the extracting module 309 calculates the assigned measuring points “MPₙ” of the “n”-th space distance group by dividing the sample number “Nₙ” contained in the “n”-th space distance group “Sₙ” by the total candidate pattern number “Nₐₗₗ” and multiplying the permissible number “PN” of the measuring points “PN” by using the equation (1).

Thereafter, the extracting module 309 extracts the test candidate patterns from the “n”-th space distance group “Sₙ” by referring to the permissible number “PN”.

In step S203, the photomask shown in FIG. 2 is inserted into the microscope 302 shown in FIG. 1. The microscope 302 observes the photomask to measure the actual dimensional errors of the test candidate patterns extracted by the extracting module 309. In step S204, the assessment module 311 calculates the index “Vₙ” of the dimensional variation of the “n”-th space distance group “Sₙ” by using the equation (2). Then, the assessment module 311 calculates the square root of the summation of the index “Vₙ” to provide the index “Q_{P}” of the photomask quality showing the dimensional variation caused by the pattern density of the photomask shown in FIG. 2. The index “Q_{P}” is given by equation (4). The assessment module 311 evaluates the index “Q_{P}” showing the dimensional variation caused by the pattern density of the photomask. The assessment module 311 stores the index “Q_{P}” in the mask data memory 310.

If the sample number evaluator 307 shown in FIG. 1 determines that the total sample number of the test candidate patterns contained in the table shown in FIG. 5 is below the permissible number “PN” of the measuring points of the microscope 302 in step S106, the microscope 302 observes the photomask to measure the actual dimensional errors of all of the test candidate patterns contained in the table shown in FIG. 5 in step S301.

In step S302, the assessment module 311 calculates the square of the standard deviation σ(Sₙ)² of the actual dimensional errors of the test candidate patterns in each of the first to “m”-th space distance groups “S₁”-“Sₘ”. Thereafter, the assessment module 311 multiplies the summation of the square of the standard deviation σ(Sₙ)² by 2α to calculate the index “Q_{P}” of the photomask quality showing the dimensional variation caused by the pattern density of the photomask shown in FIG. 2. The index “Q_{P}” is given by equation (3) . The assessment module 311 evaluates the index “Q_{P}” showing the dimensional variation caused by the pattern density of the photomask. The assessment module 311 stores the index “Q_{P}” in the mask data memory 310.

In the method for extracting the patterns described above, the test candidate patterns are classified into the first to “m”-th space distance groups “S₁”-“Sₘ” depending on the space distance to the adjacent pattern in step S102. Accordingly, the test candidate patterns classified into each one of the first to “m”-th space distance groups “S₁”-“Sₘ” have the same dimensional variation depending on the space distance. Therefore, σ(Sₙ) (n=1 to m) calculated in Step S302, and σ_{nH}, σ_{nL} (n=1 to m) calculated in Step S204 are independent from the dimensional variation depending on the space distance. Therefore, it is possible to evaluate σ(Sₙ) and σ_{nH}, σ_{nL} as an index of the dimensional variation depending on the pattern density.

The mask patterns on the photomask are corrected by the OPC to reduce the inconsistency between the dimensions of the designed patterns and the projected images on the resist layer. However, the area that can be corrected by the OPC is within 10 micro square meters on the photomask because of the computer processing time. In the earlier method, the dimensional variation caused by the pattern density of the larger area has been disregarded, as a result.

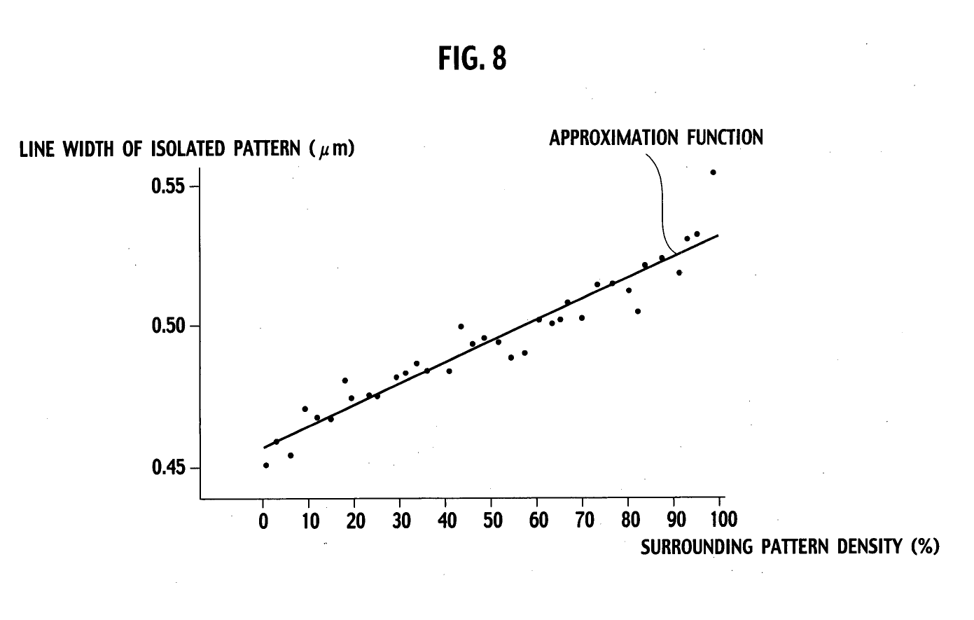

FIG. 8 is a graph showing a line width of an isolated pattern versus the surrounding pattern density. Designed line width of the isolated pattern is 0.5 micro square meters. When the surrounding pattern density of 20 square millimeters is changed from 0% to 100% in a 36 step gradation, actual line width of the manufactured isolated pattern is varied. The surrounding pattern density strongly affects the dimensional variation of the isolated pattern.

Since it is difficult to control such dimensional variation by the OPC, it is important to assess the dimensional variation caused by the pattern density. The pattern extracting system shown in FIG. 1 and the method for extracting the patterns shown in FIG. 7 make it possible to extract the mask patterns having the low lithographic process tolerance without failing to measure the biases added by the OPC as the dimensional error. Such biases change dependent on the space distance. The test candidate patterns classified into each one of the first to “m”-th space distance groups “S₁”-“Sₘ” are equally corrected by the OPC. Therefore, the dimensional variations of the classified test candidate patterns are independent from the biases added by the OPC and reflect the surrounding pattern density. Therefore, the system and the method shown in FIGS. 1 and 7 make it possible to accurately assess the dimensional variations caused by the surrounding pattern density by analyzing the standard deviations of the dimensional errors of the classified test candidate patterns. Further, it is possible to determine whether or not it is better to change the arrangement of the circuit pattern in view of the local pattern density of the photomask shown in FIG. 2 based on the index “Q_{P}” calculated in step S203 and step S302 in FIG. 7.

In the earlier method, if the number of the sampled mask patterns is above the permissible number “PN”, the mask patterns to be assessed are randomly extracted. However, by the pattern extracting system shown in FIG. 1 and the method for extracting patterns shown in FIG. 7, the test candidate patterns are further extracted from the high density group and the low density group in step S202 when the number of the test candidate patterns sampled in the step S101 is above the permissible number “PN” of the microscope 302 shown in FIG. 1. The difference between the dimensional variations in the high and low density groups is large. Therefore, it is possible to accurately assess the dimensional variation caused by the pattern density even though the test candidate patterns are extracted in step S202.

Modification

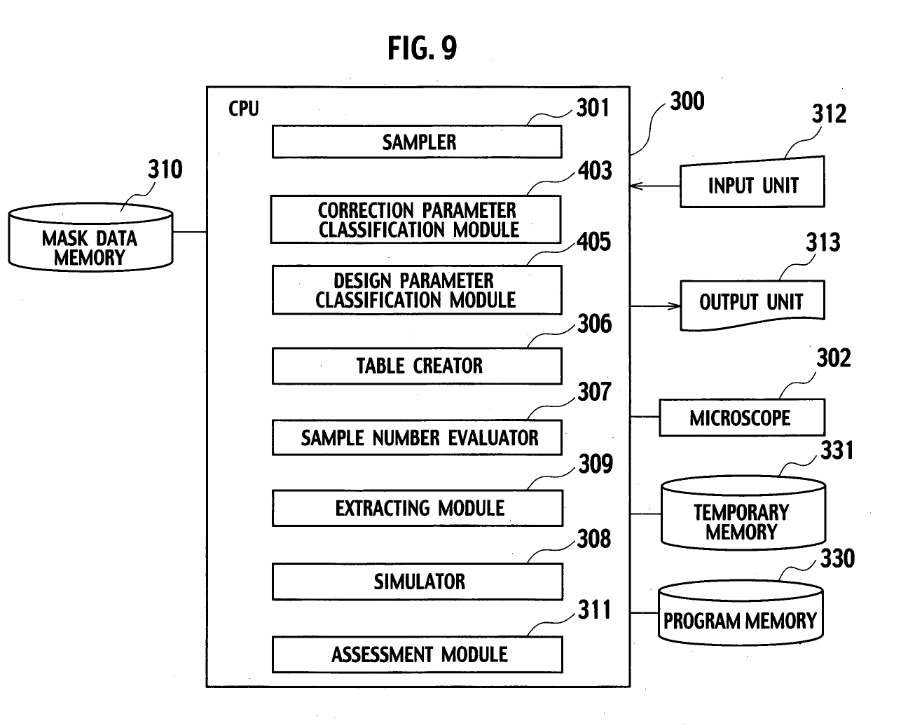

With reference to FIG. 9, a measuring points extracting system in accordance with the modification of the embodiment includes a correction parameter classification module 403 and a design parameter classification module 405 instead of including the space classification module 303 and the density classification module 305 shown in FIG. 1. Other components of the measuring points extracting system shown in FIG. 9 are similar to the pattern extracting system shown in FIG. 1.

The correction parameter classification module 403 shown in FIG. 9 classifies the test candidate patterns sampled by the sampler 301 into a first correction parameter group “C₁”, a second correction parameter group “C₂”, a third correction parameter group “C₃”, . . . , an “n”-th correction parameter group “Cₙ”, . . . and a “m”-th correction parameter group “Cₘ” depending on a correction parameter used by a mask correction such as the OPC. Here “n” is a natural number and “m” is the total number of the correction parameter groups. The “correction parameter” includes the space distance to the adjacent mask pattern, the line width of the test candidate pattern, and the shape of the test candidate pattern, for example. Information that the shape of the test pattern is a line, an end portion, or a bending portion is also the correction parameter.

The design parameter classification module 405 further classifies the test candidate patterns classified by the correction parameter classification module 403 into a first design parameter group “N₁”, a second design parameter group “N₂”, a third design parameter group “N₃”, . . . , a “q”-th design parameter group “N_{q}”, . . . , and an “r”-th design parameter group “Nᵣ” depending on a design parameter. The design parameter is not used by the mask correction such as the OPC. Here, “q” is a natural number and “r” is the total number of the design parameter groups.

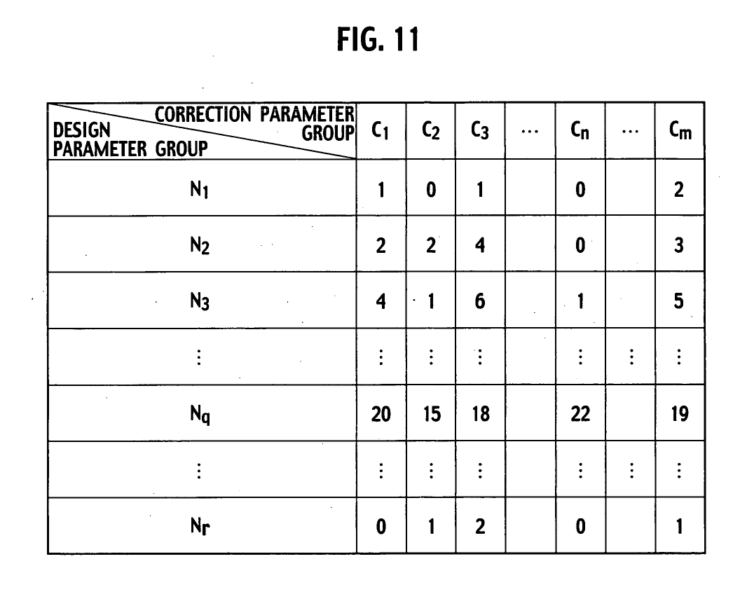

In the modification of the embodiment, the table creator 306 creates a table shown in FIG. 11. The table shows the sample number of the test candidate patterns classified into the first to “m”-th correction parameter groups “C₁”-“Cₘ” and the first to “r”-th design parameter groups “N₁”-“Nᵣ”.

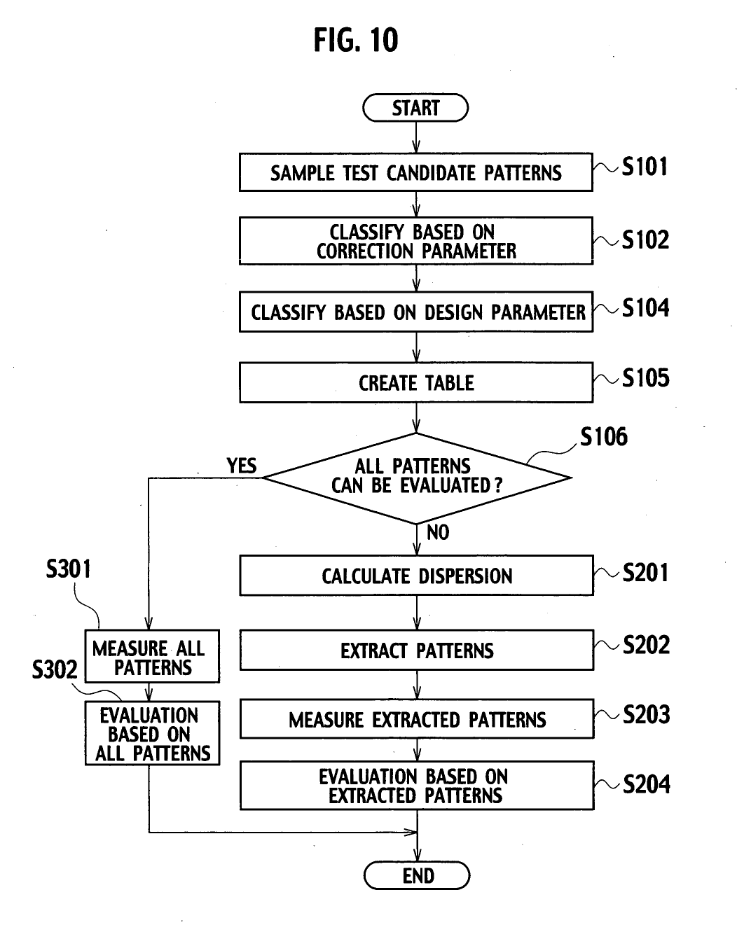

With reference to FIG. 10, a method for extracting the measuring points in accordance with the modification of the embodiment of the present invention is described.

In step S102, the correction parameter classification module 406 shown in FIG. 9 classifies the test candidate patterns sampled by the sampler 301 into the first to “m”-th correction parameter groups “C₁”-“Cₘ” depending on the correction parameter used by the OPC.

In step S104, the design parameter classification module 405 further classifies the test candidate patterns into the first to “r”-th design parameter groups “N₁”-“Nᵣ” depending on the design parameter that is not used in the OPC.

In step S105, the table creator 306 creates the table shown in FIG. 11. Thereafter, the method for extracting the measuring points is carried out as similar to the method for extracting the patterns shown in FIG. 7.

The test candidate patterns classified into each one of the first to “m”-th correction parameter groups have been equally corrected by the OPC. Therefore, the test candidate patterns classified by the same correction parameter have the same dimensional variation depending on the OPC. Therefore, the standard deviation of the dimensional variations of the test candidate patterns classified into each one of the first to “m”-th correction parameter groups reflects the design parameter.

The system and the method according to the modification of the embodiment make it possible to reveal factors effecting the dimensional variation of the mask pattern having the low lithographic process tolerance. Therefore, the system and the method according to the modification of the embodiment contribute to shrinking the mask patterns and semiconductor devices.

### Other Embodiments

Although the invention has been described above by reference to the embodiments of the present invention, the present invention is not limited to the embodiments described above. Modifications and variations of the embodiments described above will occur to those skilled in the art, in the light of the above teachings.

For example, the pattern extracting system and the method for extracting patterns shown in FIGS. 1 and 7 are applied to assess the dimensional errors of the photomask in the embodiment. However, it is possible to apply the system and the method according to the embodiment to assessment of the dimensional errors of the resist patterns formed on the resist layer. Therefore, the “circuit pattern” is not limited to the mask pattern.

In this case, a table similar to the table shown in FIG. 5 is created. Further, the table for the classified resist patterns is compared with the table shown in FIG. 5. By comparing, it is possible to assess whether the dimensional errors of the resist patterns are corrected by the OPC. Even though the mask patterns classified into one of the pattern density group have the dispersed dimensional errors, the resist pattern classified into one of the pattern density group may not have the dispersed dimensional errors in the case where the OPC is applied to the mask patterns.

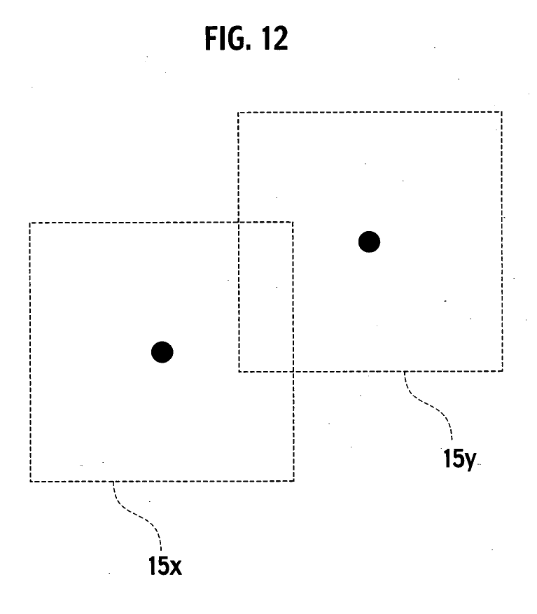

Also, in FIG. 4, the first divided area 15a, the second divided area 15b, the third divided area 15c, . . . , the “o”-th divided area 15o, . . . , and the “p”-th divided area 15p are arranged in matrix. However, as shown in FIG. 12, it is possible to arrange a divided area 15x and a divided area 15y to overlap each other.

Further, the methods for extracting the patterns and the measuring points according to the embodiments of the present invention is capable of being expressed as descriptions of a series of processing or commands for a computer system. Therefore, the methods for extracting the patterns and the measuring points are capable of being formed as a computer program product to execute multiple functions of the CPU in the computer system. “The computer program product” includes, for example, various writable mediums and storage devices incorporated or connected to the computer system. The writable mediums include a memory device, a magnetic disc, an optical disc and any devices that record computer programs.

As described above, the present invention includes many variations of the embodiments. Therefore, the scope of the invention is defined with reference to the following claims.

What is claimed is:

1. A pattern extracting system comprising:
a sampler configured to sample a plurality of test candidate patterns from a circuit pattern, based on a lithographic process tolerance;
a space classification module configured to classify the plurality of test candidate patterns into a plurality of space distance groups depending on a space distance to an adjacent pattern;
a density classification module configured to classify the plurality of test candidate patterns into a plurality of pattern density groups depending on a surrounding pattern density; and
an assessment module configured to assess actual measurements of dimensional errors of the plurality of test candidate patterns classified into the plurality of space distance groups and the plurality of pattern density groups.

2. The system of claim 1, further comprising a simulator configured to calculate the lithographic process tolerance of each of the plurality of test candidate patterns.

3. The system of claim 1, further comprising a table creator configured to create a table showing a sample number of the plurality of test candidate patterns classified into the plurality of space distance groups and the plurality of pattern density groups.

4. The system of claim 1, further comprising a microscope configured to measure the actual measurements of the dimensional errors.

5. The system of claim 4, further comprising a sample number evaluator configured to determine whether the total sample number of the test candidate patterns is above the permissible number of measuring points of the microscope.

6. The system of claim 1, further comprising an extracting module configured to extract the test candidate patterns classified into one of the space distance groups and a highest pattern density group, the highest pattern density group having the highest surrounding pattern density among the pattern density groups.

7. The system of claim 1, further comprising an extracting module configured to extract the test candidate patterns classified into one of the space distance groups and a lowest pattern density group, the lowest pattern density group having the lowest surrounding pattern density among the pattern density groups.

8. The system of claim 1, wherein the assessment module calculates a standard deviation of the actual measurements of the dimensional errors of the test candidate patterns classified into one of the space distance groups.

9. A method for extracting measuring points including:
sampling a plurality of measuring points from a circuit pattern, based on a lithographic process tolerance;
classifying the plurality of measuring points into a plurality of correction parameter groups depending on a correction parameter, the correction parameter being used to correct the circuit pattern;
classifying the plurality of measuring points into a plurality of design parameter groups depending on a design parameter, the design parameter being not used to correct the circuit pattern; and
extracting the plurality of measuring points classified into the plurality of correction parameter groups and the plurality of design parameter groups.

10. A method for extracting patterns including:
sampling a plurality of test candidate patterns from a circuit pattern, based on a lithographic process tolerance;
classifying the plurality of test candidate patterns into a plurality of space distance groups depending on a space distance to an adjacent pattern;
classifying the plurality of test candidate patterns into a plurality of pattern density groups depending on a surrounding pattern density; and
assessing actual measurements of dimensional errors of the plurality of test candidate patterns classified into the plurality of space distance groups and the plurality of pattern density groups.

11. The method of claim 10, further including:
calculating the lithographic process tolerance of each of the plurality of test candidate patterns.

12. The method of claim 10, further including:
creating a table showing a sample number of the pluraity of test candidate patterns classified into the plurality of space distance groups and the plurality of pattern density groups.

13. The method of claim 10, further including:
determining whether the total sample number of the test candidate patterns is above the permissible number of measuring points of the microscope.

14. The method of claim 10, further including:
extracting the test candidate patterns classified into one of the space distance groups and a highest pattern density group, the highest pattern density group having the highest surrounding pattern density among the pattern density groups.

15. The method of claim 10, further including:
extracting the test candidate patterns classified into one of the space distance groups and a lowest pattern density group, the lowest pattern density group having the lowest surrounding pattern density among the pattern density groups.

16. The method of claim 10, further including:
calculating a standard deviation of the actual measurements of the dimensional errors of the test candidate patterns classified into one of the space distance groups.

17. A computer program product for controlling a computer system so as to extract patterns, the computer program product comprising:
instructions configured to sample a plurality of test candidate patterns from a circuit pattern, based on a lithographic process tolerance;
instructions configured to classify the plurality of test candidate patterns into a plurality of space distance groups depending on a space distance to an adjacent pattern;
instructions configured to classify the plurality of test candidate patterns into a plurality of pattern density groups depending on a surrounding pattern density; and
instructions configured to assess actual measurements of dimensional errors of the plurality of test candidate patterns classified into the plurality of space distance groups and the plurality of pattern density groups.
